(19) United States
(12) Patent Application Publication
(10) Pub. No.: US 2010/0266330 A1
(43) Pub. Date: Oct. 21, 2010

(54) MOTOR OPERATOR ASSEMBLY

(76) Inventors: Samir Rajauria, Agra (IN); Lars Pommerencke, Neumunster (DE)

Correspondence Address: General Electric Company;GE Global Patent Operation, 2 Corporate Drive, Suite 648, Shelton, CT, 06484, US

(21) Appl. No.: 12/425,421

(22) Filed: Apr. 17, 2009

(51) Int. Cl. F16B 2/02; B23P 11/00; A47F 7/00

(52) U.S. Cl. 403/14; 29/525.01; 248/310

(57) ABSTRACT

A coupling for connecting an operator mechanism and a base plate of a motor operator assembly includes a first apparatus secured to the operator mechanism, and a second apparatus secured to the base plate, the second apparatus having one or more apertures configured for engagement with the first apparatus to form a rigid coupling between the base plate and the operator mechanism.

### FIELD

The subject matter described herein relates generally to a motor operator assembly for circuit breakers.

### RELATED ART

It is known in the art to provide molded case circuit breakers for electrical systems. The circuit breaker is operative to disengage the electrical system under certain operating conditions. The use of accessories such as, for exemplary purposes only, motor operators to allow the motor-assisted operation of electrical circuit breakers is well known. The motor operator allows the circuit breaker to be operated remotely and to be opened, closed or reset after tripping of the circuit breaker.

The motor operator is typically secured to the top of a circuit breaker housing. A lever within the motor operator mechanically interacts with a circuit breaker operating handle, which extends from the circuit breaker housing. The lever is operatively connected to a motor within the motor operator. The motor drives the lever, which, in turn, moves the operating handle to operate the circuit breaker. The operating handle is moved between “on”, “off”, and “reset” positions, depending on the rotational direction of the motor.

A plurality of buttons external to the motor operator controls electrical current to the motor. The rotational direction of the motor is changed depending on which of these buttons is selected by operating personnel. Thus, the operating personnel can select one button to place the operating handle in the “on” position, and another button to place the operating handle in the “off” or “reset” positions.

When the handle is moved to the “on” position, electrical contacts within the circuit breaker are brought into contact with each other, allowing electrical current to flow through the circuit breaker. When the handle is moved to the “off” position, the electrical contacts are separated, stopping the flow of electrical current through the circuit breaker. When the handle is moved to the “reset” position, an operating mechanism within the circuit breaker is reset, as is necessary after the operating mechanism has tripped in response to an overcurrent condition in the electrical circuit being protected by the circuit breaker.

In one example, the motor operator may include a base and a hinged top where the hinged top houses an operator mechanism. Movement may be induced between the base and the hinged top during operation of the motor operator.

It would be advantageous to be able to fix the operator mechanism to the base so that relative movement between the two during operation of the motor operator is substantially eliminated.

### BRIEF DESCRIPTION OF THE EMBODIMENTS

In accordance with one exemplary embodiment, a coupling for connecting an operator mechanism and a base plate of a motor operator assembly includes a first apparatus secured to the operator mechanism, and a second apparatus secured to the base plate, the second apparatus having one or more apertures configured for engagement with the first apparatus to form a rigid coupling between the base plate and the operator mechanism.

In accordance with another exemplary embodiment, a coupling between an operator mechanism and a base plate includes a frame in which the operator mechanism is mounted, a first apparatus secured to the frame, and a second apparatus secured to the base plate, the second apparatus having one or more apertures configured for engagement with the first apparatus to form a rigid coupling between the base plate and the operator mechanism to substantially prevent relative movement between the operator mechanism and the base plate.

In accordance with still another exemplary embodiment, a method for coupling an operator mechanism to a base plate includes securing a first apparatus to the operator mechanism, securing a second apparatus to the base plate, and coupling the first apparatus to the second apparatus to effect a rigid coupling configured to substantially prevent relative movement between the operator mechanism and the base plate.

### BRIEF DESCRIPTION OF THE DRAWINGS

The following detailed description is made with reference to the accompanying drawings, in which:

FIG. 1 is a schematic illustration of a motor operator assembly in accordance with an exemplary embodiment;

FIGS. 2 through 4 are partial schematic illustrations portions of the motor operator of FIG. 1 in accordance with an exemplary embodiment; and

FIGS. 5 and 6 are partial schematic views of a portion of the motor operator of FIG. 1 in accordance with an exemplary embodiment.

### DETAILED DESCRIPTION OF THE PREFERRED EMBODIMENTS

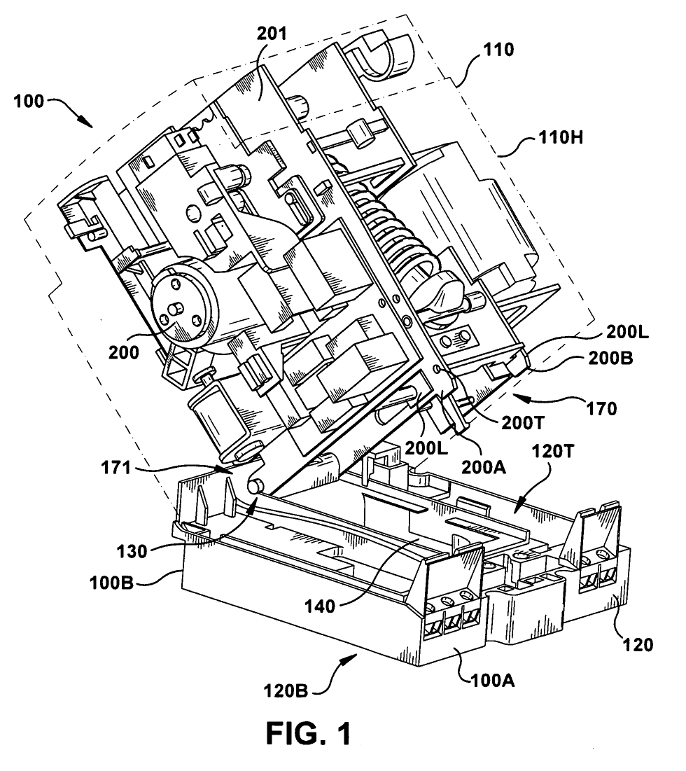

In one exemplary embodiment, referring to FIG. 1 a motor operator assembly 100 for a circuit breaker (not shown) is provided and shown in an open configuration. Although the embodiments disclosed will be described with reference to the drawings, it should be understood that the embodiments disclosed can be embodied in many alternate forms. In addition, any suitable size, shape or type of elements or materials could be used.

The exemplary embodiments provide a user friendly motor operator design having a substantially rigid coupling between a hinged top portion 110 and a base plate 120 of the motor operator assembly 100. In accordance with the exemplary embodiments, the coupling is configured to substantially prevent or eliminate the movement of the top portion 110 (and the operator mechanism 200 housed therein) relative to the base plate 120. Movement between the top portion 110 and the base plate 120 may be caused by the energy released by the operator mechanism 200 when the circuit breaker is switched between on and off states. In one example, the coupling is configured to substantially eliminate movement between the top portion 110 and base plate 120 in all degrees of freedom.

In one exemplary embodiment, the motor operator assembly 100 includes the base plate 120 and the top portion 110. The top portion 110 includes a housing 110H and a frame 201. In one example, the frame 201 may be part of or integral to an operator mechanism 200 while in other examples, the frame 201 may be configured so that the operator mechanism 200 can be mounted to the frame 201. The operator mechanism 200 and the frame 201 are substantially housed within the housing 110H where the housing 110H is mounted to the frame 201 in any suitable manner. In this example, the frame includes operator mechanism side walls 200A, 200B so as to form a first side 170 of the frame 201 and a second side 171 of the frame 201. The side walls 200A, 200B may be configured for hinged engagement with the base plate 120 at the second side 171 of the frame. For example, hinge 130 may couple the frame 201 (and hence the operator mechanism 200 and top portion 110) to the base plate 120 at the second end 100B (e.g. the end substantially opposite the first end 100A) of the motor operator so that as the motor operator assembly is opened from the first end 10A of the motor operator the top portion 110 pivots about hinge 130. In this example, at least a portion of the hinge 130 may be integrally formed on the base plate top 120T but in other examples the hinge may be any suitable hinge.

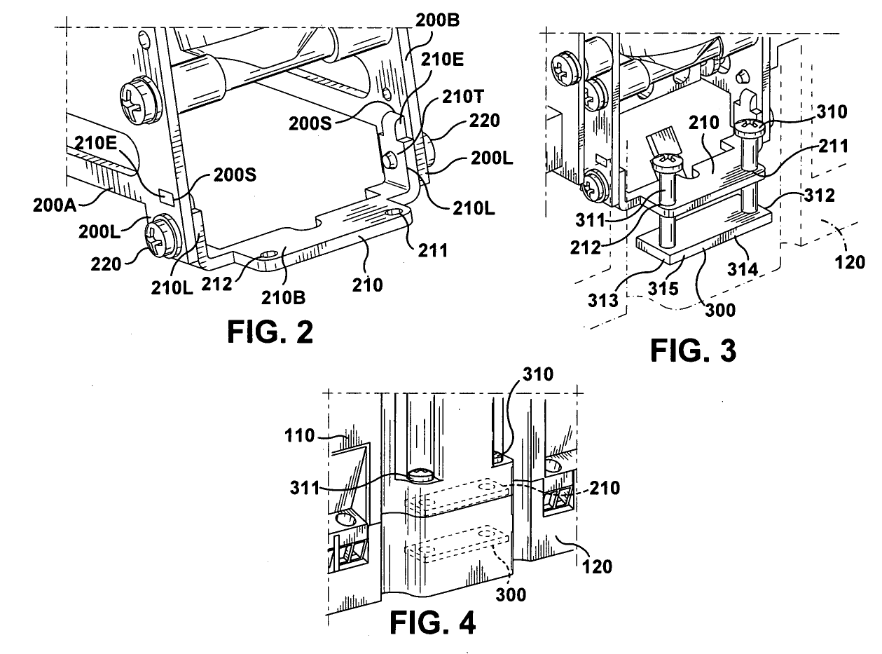

Referring also to FIG. 2, the side walls 200A, 200B may also include frame extensions 200L located at the first side 170 of the frame 201. The frame extension 200L may be configured so that a first apparatus 210 in the form of a plate may be attached to the frame 201. In one example, the frame extensions 200L may include apertures 200T (FIG. 1) and slots 200S for allowing the attachment of the first apparatus 210.

The first apparatus 210 may include a longitudinally extended base 210B and legs 210L that extend from the ends of the base 210B at an angle away from a longitudinal surface of the base. It is noted that the longitudinal axis of the base 210B extends between the frame extensions 200L such that the legs 210L are longitudinally separated from each other by the base 210B. At least a portion of the base 210B extends laterally away from the frame 201 so that one or more apertures 211, 212 of the base 210B are accessible through the housing 110H when the motor operator assembly 100 is in a closed configuration (FIG. 4). The legs 210L may be integrally formed with the base 210B such as through, for exemplary purposes only, molding, bending or stamping or any other suitable manufacturing method. The legs 210L may include extensions 210E that extend away from legs 210L at an angle for engaging respective slots 200S of the frame extensions 200L. The extensions 210E and the slots 200L may be configured to orient the first apparatus 210 relative to the frame 201 and at least partially substantially prevent relative movement between the first apparatus 210 and the frame 201. In other example, relative movement between the first apparatus 210 and frame 201 may be prevented in any suitable manner. In still other examples, the first apparatus 210 may have any suitable configuration and may be formed integrally with the side walls 200A, 200B. The legs 210L may have threaded apertures 210T that correspond with respective apertures 200T in frame extensions 200L of the side walls 200A, 200B such that fasteners 220 can be inserted through the apertures 200T for engaging the respective threaded aperture 210T for securing the first apparatus 210 to the operator mechanism 200 by way of side walls 200A, 200B of the frame 201 in conjunction with the interface between the slots 200S and the extensions 210E. In other examples, the first apparatus 210 may be secured to the operator mechanism 200 through frame 201 in any suitable manner. The base 210B of the first apparatus 210 may also include one or more apertures 211-212 for securing the first end 170 of the frame 201 to the base plate 120 when the motor operator assembly 100 is in a closed configuration as will be described below. While the first apparatus 210 is shown as having two apertures 211, 212, it should be understood that the first apparatus 210 may have one or any suitable number of apertures.

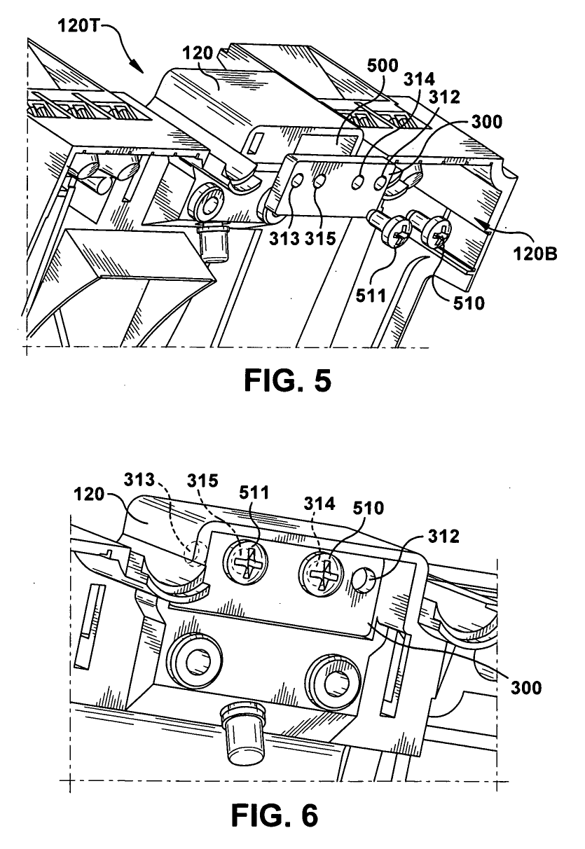

Referring now to FIGS. 3-6 the base plate bottom 120B includes a recess 500. The recess 500 is suitably sized and configured so that a second apparatus 300 in the form of a plate may be inserted into the recess 500. In one example, the second apparatus 300 may be substantially flat and include one or more apertures 312-315. In some embodiments, apertures 312, 313 may be threaded apertures. While the second apparatus 300 is shown as having four apertures 312-315, it should be understood that the second apparatus 300 may have one or any suitable number of apertures. In other examples, the second apparatus 300 may have any suitable configuration. The second apparatus 300 may be secured in the recess 500 in any suitable manner such as with fasteners 510, 511 or snaps. The fasteners 510, 511 may be inserted through, for example, apertures 314, 315 to engage corresponding threaded apertures (not shown) of the base plate 120. The fit between the recess 500 and the second apparatus 300 and/or the securing of the second apparatus 300 within the recess 500 is such that there is substantially no relative movement between the second apparatus 300 and the base plate 120.

As seen best in FIGS. 3 and 4 when the motor operator assembly 100 is in a closed configuration the first apparatus 210 and second apparatus 300 are adjacent one another such that one or more apertures 211, 212 of the first apparatus 210 are substantially aligned with respective one or more apertures 312, 313 of the second apparatus. Couplings such as, for example, fasteners 310, 311 may be inserted through their respective aperture 211, 212 in the first apparatus for engaging the threads of a respective aperture 312, 313 for securing the top portion 110 to the base plate 120 at the first end 100A of the motor operator. As can be seen in FIGS. 3 and 4 the fasteners 310, 311 may pass through a portion of the housing 110 and the base plate 120. For example, the fasteners 310, 311 may pass through apertures in the housing 110 such that the housing is sandwiched between the heads of the fasteners 310, 311 and the base 210B of the first apparatus 210 when top portion 110 is secured to the base plate 120 at the first end 100A of the motor operator. In other examples the heads of the fasteners 310, 311 may contact the base 210B directly such as where the apertures in the housing 110 are sized to allow the heads to pass through the housing 110. The fasteners may pass through apertures in the base plate 120 such that the base plate is sandwiched between the base 210B of the first apparatus 210 and the second apparatus 300 when top portion 110 is secured to the base plate 120 at the first end 100A of the motor operator. Because the first apparatus 210 is secured to the frame 201 substantially without relative movement and the second apparatus 300 is secured to the base plate 120 substantially without relative movement, when the fasteners 310, 311 are inserted through/into the first apparatus 210 and second apparatus 300 a substantially rigid coupling is formed substantially preventing relative movement between operator mechanism 200 (via the frame the frame 201) and base plate 120 of the motor operator assembly 100.

While exemplary embodiments have been described in connection with what are presently considered to be the most practical and preferred embodiments, it is to be understood that the embodiments are not limited to those disclosed herein. Rather, the embodiments described are intended to cover all of the various modifications and equivalent arrangements included within the spirit and scope of the appended claims.

What is claimed is:

1. A coupling for connecting an operator mechanism and a base plate of a motor operator assembly, comprising:
a first apparatus secured to the operator mechanism; and
a second apparatus secured to the base plate, the second apparatus having one or more apertures configured for engagement with the first apparatus to form a rigid coupling between the base plate and the operator mechanism.

2. The coupling of claim 1, wherein the operator mechanism comprises:
a frame having side walls, wherein the first apparatus comprises a longitudinally extended base, the first apparatus further comprising a leg that extends from a longitudinal surface of the base, the leg being configured to secure the first apparatus to the side walls.

3. The coupling of claim 2, further comprising a housing mounted on the frame, the longitudinally extended base of the first apparatus having apertures therethrough configured for engagement with the operator mechanism.

4. The coupling of claim 2, wherein the side walls are further configured with slots and the leg further comprises an extension configured to engage the slots in the side walls.

5. The coupling of claim 1, wherein a first end of the base plate further comprises a recess.

6. The coupling of claim 5, wherein the first apparatus is rigidly secured to the base plate.

7. The coupling of claim 5, wherein the first apparatus plate is secured within the recess with fasteners.

8. The coupling of claim 1, wherein the first apparatus and the second apparatus are positioned such that when the motor operator assembly is in a closed configuration the first apparatus and the second apparatus are disposed adjacent one another at a first end of the motor operator assembly.

9. A coupling between an operator mechanism and a base plate, the coupling comprising:
a frame to which the operator mechanism is mounted;
a first apparatus secured to the frame; and
a second apparatus secured to the base plate, the second apparatus having one or more apertures configured for engagement with the first apparatus to form a rigid coupling with the base plate and the operator mechanism.

10. The coupling of claim 9, wherein the first apparatus comprises a longitudinally extended base, the first apparatus further comprising a leg that extends from an end of the base the leg being configured to secure the first apparatus to the frame.

11. The coupling of claim 10, wherein a housing is mounted to the frame, the longitudinal surface of the longitudinally extended base of the first apparatus having apertures therethrough, and wherein the apertures are accessible through the housing when the motor operator assembly is in a closed configuration.

12. The coupling of claim 10, wherein the frame includes a slot and the leg includes a portion that extends away from the leg to engage the slot.

13. The coupling of claim 9, wherein the second apparatus is secured within a recess formed in a bottom surface of the base plate.

14. The coupling of claim 13, wherein the second apparatus is rigidly secured within the recess.

15. The coupling of claim 14, wherein the second apparatus is secured by a fit between the second apparatus and the recess.

16. The coupling of claim 9, wherein the frame is hingably coupled to the base plate at an end of the base plate substantially opposite the rigid coupling.

17. A method for coupling an operator mechanism to a base plate, the method comprising:
securing a first apparatus to the operator mechanism;
securing a second apparatus to the base plate; and
coupling the first apparatus to the second apparatus to effect a rigid coupling.

18. The method of claim 17, further comprising disposing the first apparatus and second apparatus adjacent one another at a first end of the base plate.

19. The method of claim 18, further comprising hinging the operator mechanism to the base plate at a second end of the base plate.

20. The method of claim 17, further comprising coupling the first apparatus to the second apparatus by inserting a fastener through the first apparatus and engaging the fastener to the second apparatus.
